(19) United States
(12) Patent Application Publication
(10) Pub. No.: US 2011/0037284 A1
(43) Pub. Date: Feb. 17, 2011

(54) MANIPULATOR

(75) Inventors: QI-YU PAN, Shenzhen City (CN); AI-JUN TANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/629,223

(22) Filed: Dec. 2, 2009

(30) Foreign Application Priority Data
Aug. 12, 2009 (CN) 200910305540.X

(51) Int. Cl. B25J 15/00; B66C 1/54

(52) U.S. Cl. 294/93

(57) ABSTRACT

A manipulator includes a main portion and an acquisition assembly. The acquisition assembly is disposed on the main portion for acquiring a hollow workpiece. The acquisition assembly includes a support body and two positioning members disposed on the support body. The positioning members are sliably connected to the support body. The positioning members are movably away from the axis of the support body to acquire the hollow workpiece.

### BACKGROUND

1. Technical Field

The present disclosure relates generally to manipulators and, more particularly, to a manipulator for acquiring hollow workpieces.

2. Description of Related Art

Manipulators frequently used in manufacturing can include a main body, an assembly plate, and two cylinders. The assembly plate is fixed to an end of the main body. The cylinders are positioned on the assembly plate opposite to each other. Each cylinder includes a housing and a piston-rod slidably connected to the main body. A claw is fixed to each piston-rod. The claws resist opposite surfaces of a workpiece to acquire the workpiece, when the piston-rods extend out of the main body.

However, if the workpiece is hollow, and an entire outer surface thereof is to be processed, the claws must resist different areas of the workpiece. Accordingly, the machining efficiency of the workpiece is lowered, and the machined outer surface of the workpiece may be damaged.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an embodiment of a manipulator, including a main portion and an acquisition assembly.

FIG. 2 is an exploded, isometric view of the acquisition assembly of FIG. 1.

FIG. 3 is similar to FIG. 2, but viewed from another aspect.

FIG. 4 is an assembled, isometric of the acquisition assembly of FIG. 2.

### DETAILED DESCRIPTION

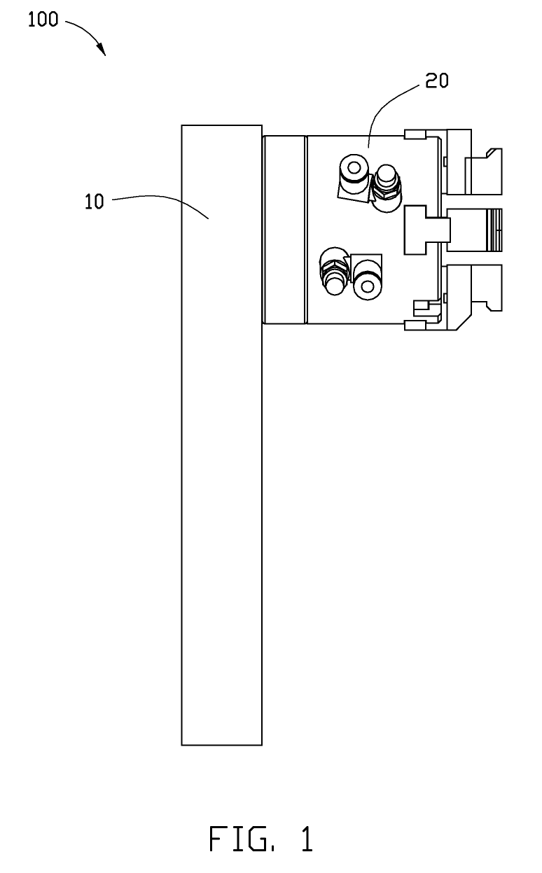

Referring to FIG. 1, an embodiment of a manipulator 100 includes a main portion 10 and an acquisition assembly 20 fixed to the main portion 10. The manipulator 100 is configured for acquiring a hollow workpiece.

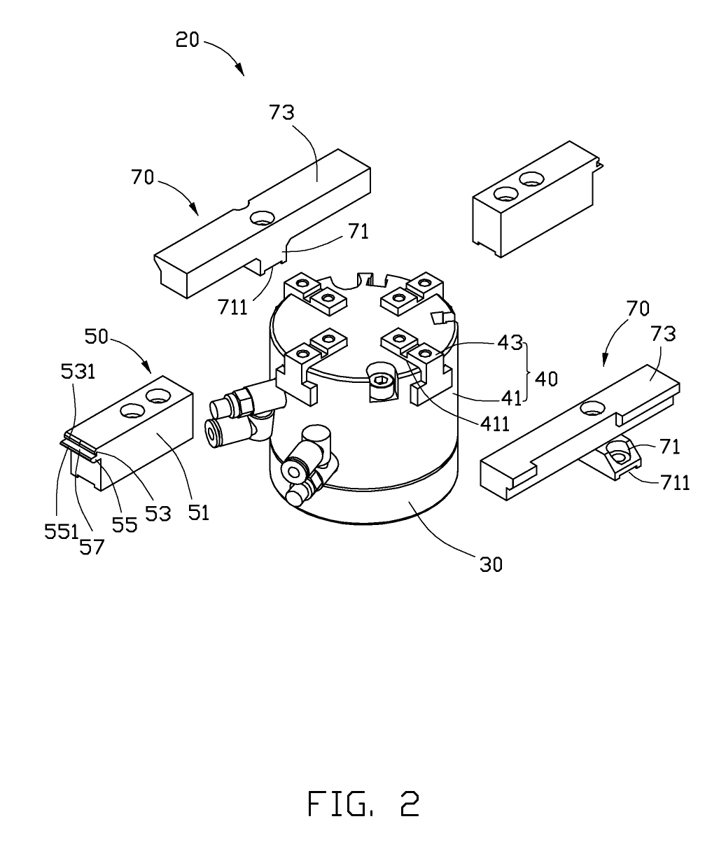

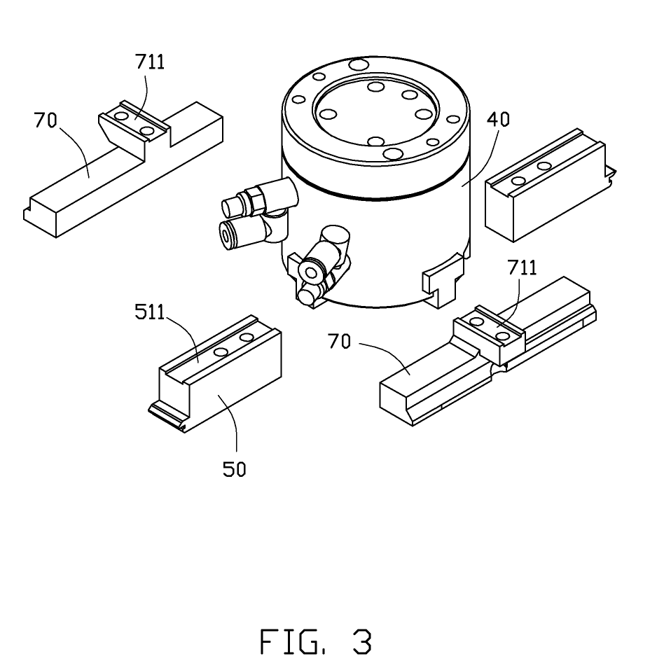

Referring to FIGS. 2 and 3, the acquisition assembly 20 includes a connecting member 30, a support body 40, two positioning members 50, and two resisting members 70. The positioning members 50 and the resisting members 70 are assembled on the support body 40, with the positioning members 50 opposite to each other and the resisting members 70 opposite to each other. The connecting member 30 rotatably connects the support body 40 to the main portion 10. In the illustrated embodiment, the connecting member 30 is a bearing.

The support body 40 includes an assembly portion 41 and a plurality of sliding portions 43. The assembly portion 41 forms a plurality of guide rails 411 on a top surface thereof. The sliding portions 43 are slidably disposed on the guide rails 411. In the illustrated embodiment, the support body 40 includes four sliding portions 43 and four guide rails 411 evenly arranged on the top surface of the assembly portion 41. The assembly portion 41 can be substantially cylindrical. The sliding portions 43 slide on the guide rails 411 by compressed air.

Each positioning member 50 includes a sliding body 51. A first positioning portion 53 and a second positioning portion 55 are formed substantially parallel on a side surface of the sliding body 51. The sliding body 51, the first positioning portion 53, and the second positioning portion 55 cooperatively define a receiving groove 57. The sliding body 51 further defines an assembly groove 511 in a bottom surface for receiving the sliding portion 43. A first chamfer angle 531 is formed at an end of the first positioning portion 53 away from the sliding body 51. A second chamfer angle 551 is formed at an end of the second positioning portion 55 away from the sliding body 51.

Each resisting member 70 includes a fixing portion 71 and an elongated resisting portion 73 connected substantially perpendicular to the fixing portion 71. The fixing portion 71 defines an assembly groove 711 in a bottom surface.

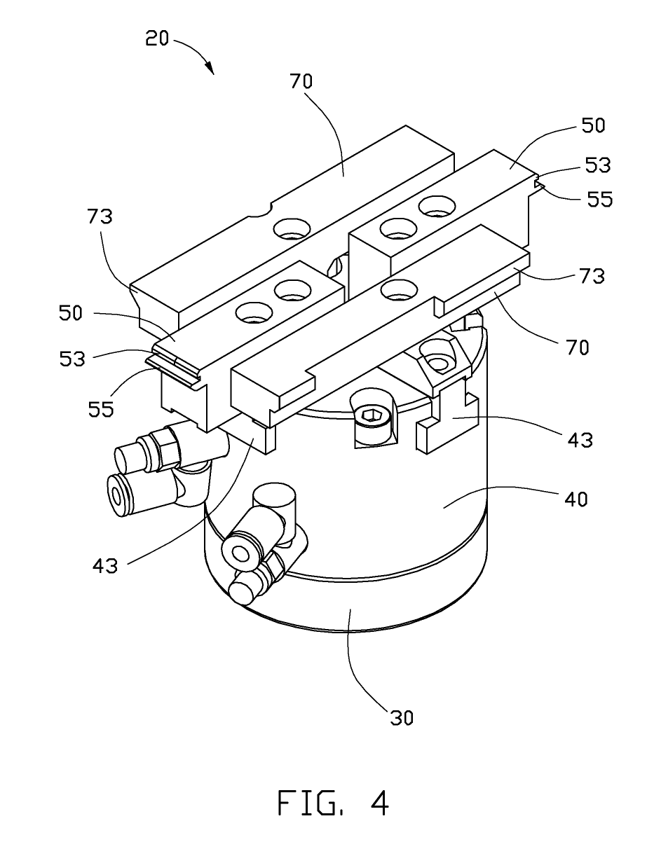

Referring to FIGS. 2 through 4, during assembly of the manipulator 100, the positioning members 50 are positioned on the support body 40 with the sliding portions 43 engaging with the assembly grooves 511 of the positioning members 50, and the positioning members 50 are fixed to the sliding portions 43 via fasteners (not shown). The resisting members 70 are positioned on the support body 40 with the sliding portions 43 engaging the assembly grooves 711 of the resisting members 70, and the resisting members 70 are fixed to the sliding portions 43 via fasteners. The connecting member 30 connects the support body 40 to the main portion 10.

In use, the sliding portions 43 slide on the guide rails 411 towards the axis of the support body 40, so that the positioning members 50 and the resisting members 70 move towards the axis of the support body 40. After that, the main portion 10 moves, bringing the acquisition assembly 20 into a cavity of the workpiece (not shown). The sliding portions 43 slide on the guide rails 411 away from the axis of the support body 40, so that the positioning members 50 and the resisting members 70 move away from the axis of the support body 40 until the positioning members 50 and the resisting members 70 resist the inner surface of the workpiece. The workpiece is then acquired by the acquisition assembly 20. In the illustrated embodiment, two protrusions (not shown) opposite to each other are formed on the inner surface of the workpiece. When the positioning members 50 resist the inner surface of the workpiece, the protrusions engage in the receiving grooves 57 of the positioning members 50. The first chamfer angle 531 of the first positioning portion 53 and the second chamfer angle 551 of the second positioning portion 55 easily engage with the protrusions in the receiving groove 57.

The acquisition assembly 20 of the manipulator 100 acquires the workpiece via the positioning members 50 and the resisting members 70. An outer surface of the workpiece can be entirely machined in one pass, increasing machining efficiency.

In an alternative embodiment, the acquisition assembly 20 may include only the positioning members 50, which in this case may be a curved bar to firmly hold the workpiece.

It should be pointed out that the positioning members 50 may not define the receiving groove 57, when no protrusions are formed on the inner surface of the workpiece. In addition, one positioning member 50 and one resisting member 70 may be fixed to the support body 40, with the other positioning member 50 and the other resisting member 70 slidably connected to the support body 40. The positioning members 50 and the resisting members 70 can be directly disposed on the guide rails 411, and moved by a driving device, such as a motor. The acquisition assembly 20 may also include four or more positioning members 50 and four or more resisting members 70 disposed on the support body 40.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A manipulator, comprising:
a main portion; and
an acquisition assembly disposed on the main portion for acquiring a hollow workpiece, the acquisition assembly comprising:
a support body; and
at least two positioning members disposed on the support body, at least one of the at least two positioning members being slidably connected to the support body and movable away from the axis of the support body to acquire the hollow workpiece.

2. The manipulator of claim 1, wherein the support body comprises an assembly portion and a plurality of sliding portions slidably connected to the assembly portion, wherein the at least two positioning members are fixed to the sliding portions.

3. The manipulator of claim 2, wherein the assembly portion is substantially cylindrical; the sliding portions are driven to slide by compressed air.

4. The manipulator of claim 2, wherein the assembly portion forms a plurality of guide rails evenly arranged on a top surface thereof, the sliding portions are disposed on the guide rails.

5. The manipulator of claim 2, wherein each of the at least two positioning members comprises a sliding body, a first positioning portion, and a second positioning portion substantially parallel to the first positioning portion; the first positioning portion and the second positioning portion are formed on a side surface of the sliding body; the sliding body, the first positioning portion, and the second positioning portion cooperatively define a receiving groove.

6. The manipulator of claim 5, wherein the sliding body defines an assembly groove for receiving the sliding portion.

7. The manipulator of claim 5, wherein a first chamfer angle is formed at an end of the first positioning portion away from the sliding body.

8. The manipulator of claim 7, wherein a second chamfer angle is formed at an end of the second positioning portion away from the sliding body.

9. The manipulator of claim 1, wherein the acquisition assembly further comprises at least two resisting members slidably disposed on the support body and adjacent to the positioning members.

10. The manipulator of claim 9, wherein each of the at least two resisting members comprises a fixing portion and an elongated resisting portion substantially perpendicular to the fixing portion and connecting the fixing portion.

11. The manipulator of claim 9, wherein the acquisition assembly further comprises a connecting member rotatably connecting the support body to the main portion.
